(19) United States
(12) Patent Application Publication
(10) Pub. No.: US 2017/0367124 A1
(43) Pub. Date: Dec. 21, 2017

(54) ARRANGEMENT FOR, AND METHOD OF, ESTABLISHING A BLUETOOTH® PAIRED CONNECTION BETWEEN A WIRELESS, ELECTRO-OPTICAL READER AND ONE OR MORE HOSTS

(71) Applicant: SYMBOL TECHNOLOGIES, LLC, LINCOLNSHIRE, IL (US)

(72) Inventors: KENNETH S. BHELLA, STONY BROOK, NY (US); MARIYA WRIGHT, CORTLANDT MANOR, NY (US)

(21) Appl. No.: 15/182,673

(22) Filed: Jun. 15, 2016

(51) Int. Cl. H04W 76/02; H04W 4/00

(52) U.S. Cl. CPC H04W 76/02; H04W 4/008

(57) ABSTRACT

A wireless, Bluetooth® paired connection is established between a wireless, electro-optical reader and a host by reading a multi-parameter, pairing symbol displayed by the host. An identification parameter is extracted from the pairing symbol to automatically identify the host, and one or more configuration parameters are substantially simultaneously extracted from the same pairing symbol to automatically configure the paired connection between the reader and the host.

### BACKGROUND OF THE INVENTION

The present disclosure relates to an arrangement for, and a method of, establishing a wireless, Bluetooth® paired connection between a wireless reader for electro-optically reading symbols and one or more hosts.

Moving laser beam readers, also known as laser scanners, and solid-state imager readers, also known as imaging scanners, have both been used as data capture devices to electro-optically read targets, such as one-dimensional bar code symbols, particularly of the Universal Product Code (UPC) type, in many different kinds of venues, such as retailers, hospitals, libraries, warehouses, and so on. Both types of readers can be operated in a portable, wireless, handheld mode, in which a user holds the respective wireless reader in his or her hand, and aims the respective reader at a symbol, and then initiates the data capture and the reading of the symbol by manual actuation of a trigger on the respective reader. Both types of wireless readers can also be operated in a fixed presentation mode. Electrical power to electronic components in the wireless reader can be supplied via a rechargeable battery in the reader.

As advantageous as such wireless readers are in reading symbols, their functionality and their usage can be enhanced by connecting and pairing them to Bluetooth®-capable mobile hosts, such as desktop or laptop computers, smartphones, tablets, smartwatches, smartglasses, or like devices or terminals. A radio frequency (RF) transceiver, e.g., a Bluetooth® module, in each type of wireless reader communicates data, including data indicative of the symbol being read, as well as control data and update data, over a bi-directional, wireless channel with a corresponding Bluetooth® module located in the host. As is well known, Bluetooth® is an open wireless technology standard for exchanging data over short distances (using short-wavelength radio transmissions in the industrial, scientific and medical (ISM) RF band from 2400-2480 MHz) between fixed and/or mobile devices, creating personal area networks with high levels of security.

However, establishing a paired connection between such Bluetooth®-capable readers and such Bluetooth®-capable hosts has not been very user friendly. A particular venue may have multiple hosts, each having a different identification number, each operating under a different operating system, and each being configured with a different communications profile. A particular reader may be set with factory default settings, which may or may not have been changed by the user of the reader. To accommodate all such variables, many separate pairing actions have to be performed in a predetermined sequence to establish the paired connection. Performing these separate pairing steps in the correct order takes a non-negligible amount of time. All of these separate pairing steps have to be repeated each time a reader is to be paired with a different host. This poses a time-consuming problem and an inconvenient, tedious procedure for users who must frequently configure their readers over and over again during a reading session.

Accordingly, there is a need to reduce the number of steps needed to establish a Bluetooth® paired connection between a Bluetooth®-capable host and a Bluetooth®-capable reader, and to more rapidly, conveniently, reliably, and simply make said paired connection, especially in a venue having multiple hosts having different identification numbers and/or operating under different operating systems and/or being configured with different communications profiles.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic view of a Bluetooth®-capable reader connected via a Bluetooth® paired connection to a Bluetooth®-capable host configured as a smartphone in accordance with one embodiment of the present disclosure.

FIG. 2 is a schematic view of the same Bluetooth®-capable reader connected via a Bluetooth® paired connection to a Bluetooth®-capable host configured as a desktop computer in accordance with another embodiment of the present disclosure.

FIG. 3 is a schematic block diagram of an imager-based embodiment of the Bluetooth®-capable reader that is paired to the host of FIG. 1 or FIG. 2.

FIG. 4 is a schematic block diagram of a laser-based embodiment of the Bluetooth®-capable reader that is paired to the host of FIG. 1 or FIG. 2.

FIG. 5 is an enlarged, front view of a multi-parameter pairing symbol displayed by the host of FIG. 1 or FIG. 2, and diagrammatically depicting various parameters encoded in the pairing symbol.

FIG. 6 is a flow chart depicting steps performed in accordance with the method of the present disclosure.

Skilled artisans will appreciate that elements in the figures are illustrated for simplicity and clarity and have not necessarily been drawn to scale. For example, the dimensions and locations of some of the elements in the figures may be exaggerated relative to other elements to help to improve understanding of embodiments of the present invention.

The arrangement and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

One aspect of this disclosure relates to an arrangement for establishing a wireless, Bluetooth® paired connection between a host and a wireless reader for electro-optically reading symbols. The arrangement includes a host controller associated with the host. The host controller generates a multi-parameter, pairing symbol that includes an identification parameter for identifying the host, and that further includes at least another configuration parameter for configuring the paired connection between the reader and the host. A host Bluetooth® module is associated with the host, and is controlled by the host controller. A data capture assembly is associated with the reader, and electro-optically reads the pairing symbol. A reader controller is associated with the reader, and controls the data capture assembly. A reader Bluetooth® module is associated with the reader, and is controlled by the reader controller. The reader controller establishes the paired connection between the host Bluetooth® module and the reader Bluetooth® module by extracting the identification parameter from the pairing symbol to automatically identify the host, and by substantially simultaneously extracting the configuration parameter from the same pairing symbol to automatically configure the paired connection between the reader and the host.

Advantageously, an actuator, such as a manually-actuatable trigger, is provided on the reader to initiate reading of the pairing symbol when actuated, and the reader controller extracts the parameters from the pairing symbol in response to a single actuation of the actuator, e.g., a single pull of the trigger. The actuator could also operate automatically, or in response to a command signal. The configuration parameter preferably includes a pairing parameter to identify that a symbol being read is the pairing symbol, and/or a default parameter to set the reader to a known default state, and/or a protocol parameter to identify a communication profile being used by the host, and/or an operating system parameter to identify an operating system being used by the host. The protocol parameter is preferably selected from a group that includes a human interface device (HID) profile, a simple serial interface (SSI) profile, a serial port profile (SPP), and a Bluetooth® made for iOS (MFi) profile. The host may be one of a plurality of hosts operative for generating a corresponding plurality of pairing symbols, each unique for each host. A display is preferably associated with each host, and the host controller preferably displays the respective pairing symbol on the respective display.

A method of establishing a wireless, Bluetooth® paired connection between a host and a wireless reader for electro-optically reading symbols, in accordance with another aspect of this disclosure, is performed by generating a multi-parameter, pairing symbol that includes an identification parameter for identifying the host, and that further includes at least another configuration parameter for configuring the paired connection between the reader and the host. The method is further performed by associating a host Bluetooth® module with the host; by electro-optically reading the pairing symbol; by associating a reader controller and a reader Bluetooth® module with the reader; and by establishing the paired connection between the host Bluetooth® module and the reader Bluetooth® module by extracting the identification parameter from the pairing symbol to automatically identify the host, and by substantially simultaneously extracting the configuration parameter from the same pairing symbol to automatically configure the paired connection between the reader and the host.

Thus, the number of steps needed to establish a Bluetooth® paired connection between a Bluetooth®-capable host and a Bluetooth®-capable reader has been reduced, preferably to a single step. The paired connection can now be more rapidly, conveniently, reliably, and simply made by simply scanning the pairing symbol, and by extracting the identification and configuration parameters from the scanned pairing symbol.

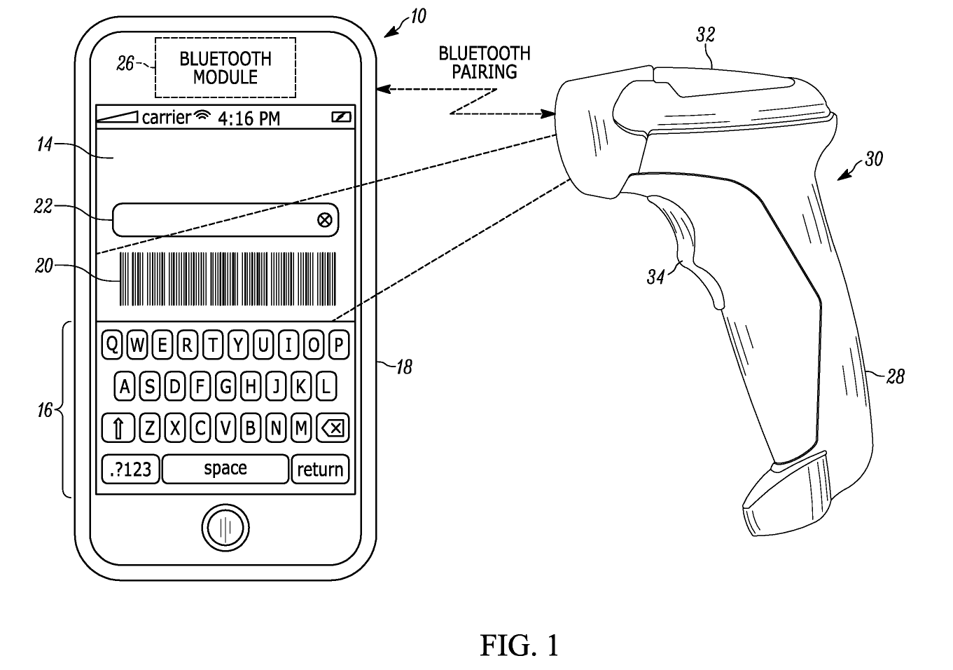

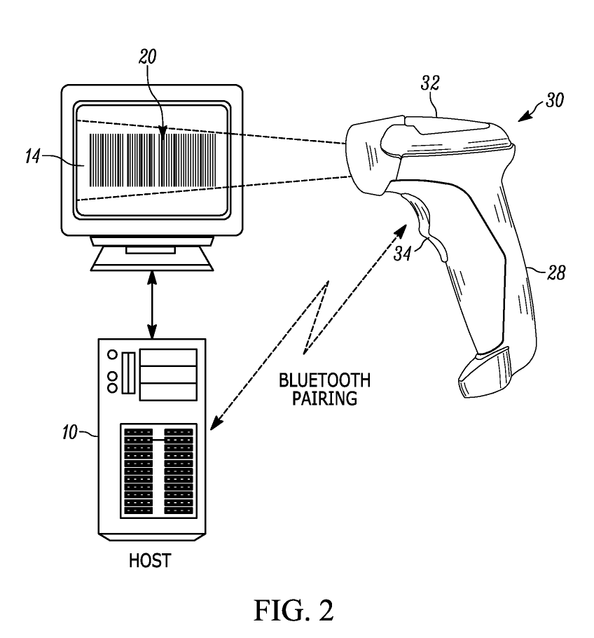

Turning now to the drawings, FIGS. 1-2 depicts a wireless, Bluetooth®-capable, handheld reader 30 for electro-optically reading targets, such as bar code symbols. The reader 30 is wirelessly connected to, and, in accordance with this disclosure, is paired with, a Bluetooth®-capable host 10 configured and illustrated as a smartphone in FIG. 1, and as a desktop computer in FIG. 2. Other hosts, such as laptop computers, tablets, smartwatches, smartglasses, servers, and like devices and terminals are also contemplated by this disclosure. The reader 30 preferably includes a portable, handheld housing 32 having a handle 28 on which a manually actuatable trigger 34 for initiating reading is mounted. It will be understood that reading could also be initiated automatically, or in response to a command signal. It will be further understood that the reader 30 could also be a fixed, non-handheld, presentation-type reader.

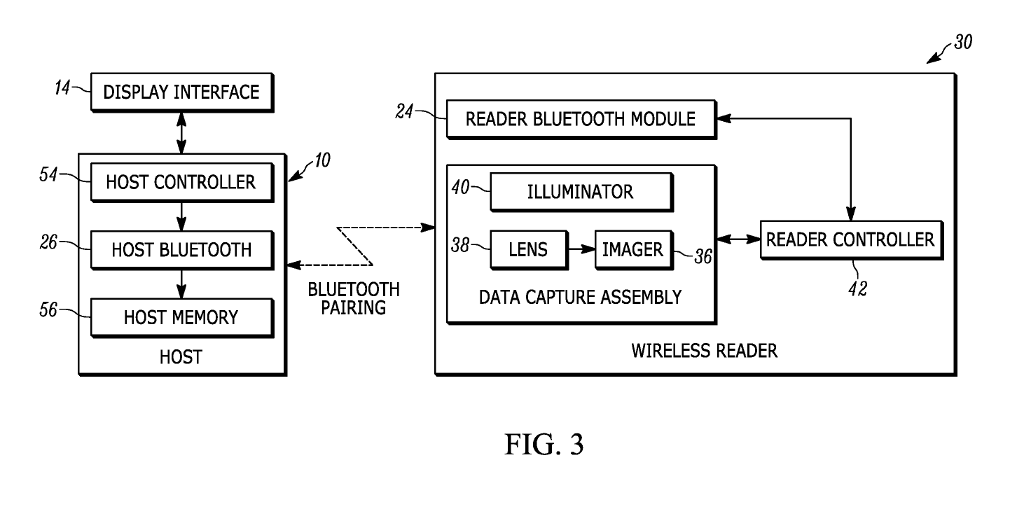

In one embodiment of the reader 30, FIG. 3 schematically depicts, in a block diagram, an imaging reader for imaging symbols to be electro-optically read by image capture. The imaging reader of FIG. 3 includes a data capture assembly mounted in the portable, handheld housing 32. The data capture assembly includes a one- or two-dimensional, solid-state imager 36, preferably a charge coupled device (CCD) array, or a complementary metal oxide semiconductor (CMOS) array, an imaging lens assembly 38, and an illuminator 40 for illuminating the target. The imager 36 has an array of image sensors operative, together with the imaging lens assembly 38, for capturing return illumination light reflected and/or scattered from a symbol to produce an electrical signal indicative of a captured image for subsequent processing by a reader controller 42. In operation, the reader controller 42 sends a command signal to drive the illuminator 40, and energizes the imager 36 during an exposure time period of a frame to collect return light from the symbol during a short time period, say 500 microseconds or less. A typical array needs about 11-33 milliseconds to read the entire symbol image and operates at a frame rate of about 30-90 frames per second. The array may have on the order of one million addressable image sensors.

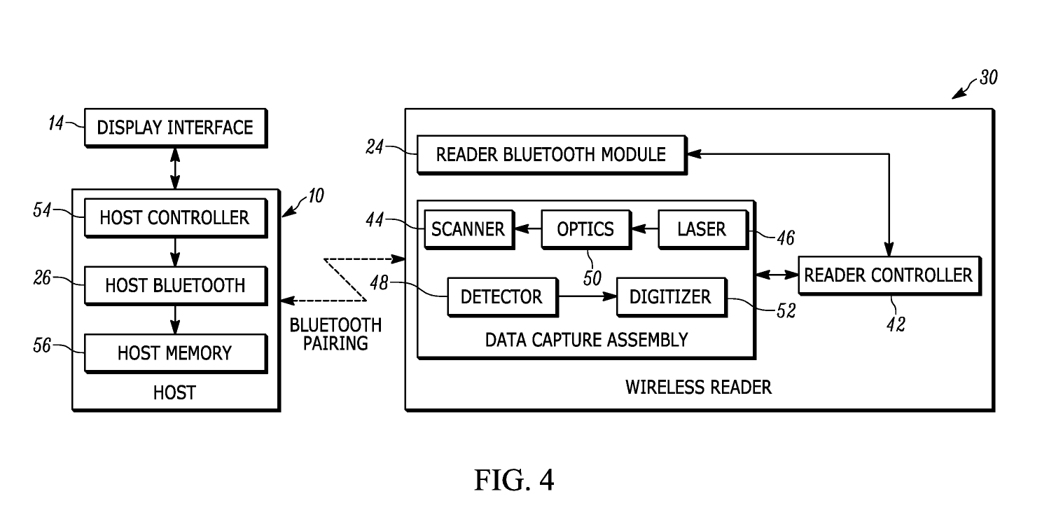

In another embodiment of the reader 30, FIG. 4 schematically depicts, in a block diagram, a moving laser beam reader operative for electro-optically reading symbols by scanning a laser beam. The beam reader of FIG. 4 includes a data capture assembly mounted in the portable, handheld housing 32. The data capture assembly includes a scanner 44 for scanning an outgoing laser beam from a laser 46 and/or a field of view of a light detector or photodiode 48 in a scan pattern, typically comprised of one or more scan lines, multiple times per second, for example, one-hundred times per second, across the symbol for reflection or scattering therefrom as return light detected by the photodiode 48 during reading. The beam reader 30 also includes a focusing lens assembly or optics 50 for optically modifying the outgoing laser beam to have a large depth of field, and a digitizer 52 for converting an electrical analog signal generated by the detector 48 from the return light into a digital signal for subsequent decoding by the reader controller 42 into data indicative of the symbol being read.

As shown in FIGS. 3-4, the reader controller 42 also controls a reader Bluetooth® module 24. The reader Bluetooth® module 24 provides bi-directional communication with a host Bluetooth® module 26 in the host 10, as described below, via a Bluetooth® wireless link and can be implemented as, for example, a radio frequency (RF) transceiver. The reader Bluetooth® module 24 receives data to be transmitted from the reader controller 42. As noted above, Bluetooth® is an open wireless standard for short-range transmission of digital data between devices and supports point-to-point and multipoint applications.

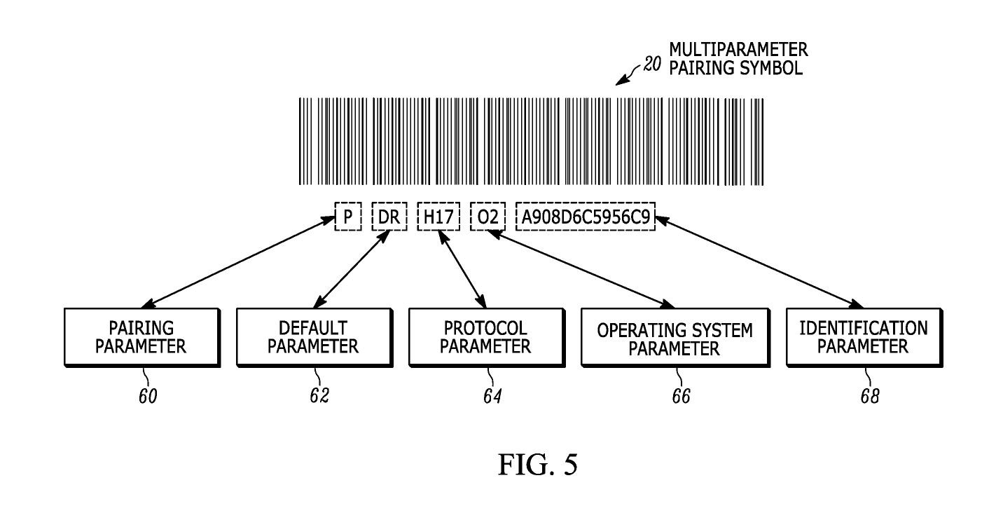

Returning to FIG. 1, the host 10 includes a handheld case 18 and an onboard touch screen or display 14 on the case 18. A soft or virtual keyboard 16, a text entry data field 22, and a multi-parameter, pairing symbol 20, as described below in detail in connection with FIG. 5, may appear on the display 14. In FIG. 2, the host 10 is a stand-alone device that is connected to a remote monitor that includes the display 14. As shown in FIGS. 3-4, a host controller 54 in the host 10 controls the host Bluetooth® module 26 for establishing a wireless, Bluetooth® paired connection with the reader Bluetooth® module 24 in the reader 30. More particularly, the Bluetooth® paired connection is established by first pairing the reader 30 to an operating system of the host 10, and then by connecting the reader 30 to an application running on the host 10. A host memory 56 stores data and is accessed by the host controller 54.

In accordance with one aspect of this disclosure, the host controller 54 generates the multi-parameter, pairing symbol 20. The pairing symbol 20 may be electronically displayed on the onboard display 14 (FIG. 1) or on the remote display 14 (FIG. 2). The pairing symbol 20 may also be printed on a label and affixed to an exterior surface of the host 10, or to a surface adjacent to the host 10. The data capture assembly of either FIG. 3 or FIG. 4 is operative for electro-optically reading the pairing symbol 20, and the reader controller 42 establishes the paired connection between the host Bluetooth® module 26 and the reader Bluetooth® module 24 by extracting parameters from the pairing symbol 20.

More particularly, as shown in FIG. 5, the pairing symbol 20 may be encoded with a plurality of parameters. For example, a first parameter may be a 1-byte pairing parameter 60 signified by an indicator “P” to identify that a symbol being currently read is indeed the pairing symbol 20. A second parameter may be a 2-byte default parameter 62 signified by an introductory indicator “D” and followed by either a subsequent indicator “F” to set the reader to a known factory default state, or by a subsequent indicator “R” to restore the reader to a known factory default state after a user has changed the reader settings. Other default states are also contemplated.

A third parameter may be a 3-byte protocol parameter 64 signified by an introductory indicator “H” and followed by a 2-byte, subsequent code to identify a communication profile being used by the host 10. The communication profile is preferably stored in the host memory 56. For example, one profile code could identify a human interface device (HID) uni-directional or keyboard profile, another profile code could identify a simple serial interface (SSI) bi-directional profile, still another profile code could identify a serial port profile (SPP) that is uni-directional, and yet another profile could identify a Bluetooth® made for iOS (MFi) profile. Other communication profiles are also contemplated. A fourth parameter may be a 2-byte operating system parameter 66 signified by an introductory indicator “O” and followed by a subsequent system code to identify an operating system being used by the host 10. The operating system is preferably stored in the host memory 56. For example, one system code could identify an iOS mobile operating system available from Apple, Inc. of Cupertino, Calif.; another system code could identify an Android mobile operating system available from Google, Inc. of Mountain View, Calif.; and still another system code could identify a Windows mobile operating system available from Microsoft Corporation of Redmond, Wash. Other system codes, such as Linux and others, are also contemplated.

The aforementioned first through fourth parameters 60, 62, 64, 66 are configuration parameters for configuring the paired connection between the reader 30 and the host 10. A fifth parameter is a 13-byte identification parameter 68 signified by an introductory indicator “A” and followed by a 12-byte identification code to identify the host 10. The identification code is preferably a media access control (MAC) address of the host 10. The MAC address is preferably stored in the host memory 56.

In operation, the reader controller 42 first generates and displays the pairing symbol 20. This can be done, for example, by entering text in the data field 22, or by opening and running an application on the host 10. Next, after the pairing symbol 20 has been read by the reader 30, the reader controller 42 establishes the paired connection between the host Bluetooth® module 26 and the reader Bluetooth® module 24 by extracting one or more of the aforementioned parameters from the same pairing symbol 20 to not only automatically identify the host 10, but also to substantially simultaneously automatically configure the paired connection between the reader 30 and the host 10. Actuation of an actuator, such as the manually-actuatable trigger 34 on the reader 30, initiates reading of the pairing symbol 20, and the reader controller 42 extracts one or more of the aforementioned parameters from the pairing symbol 20 in response to a single actuation of the actuator, e.g., a single pull of the trigger 34. If it is desired to establish a paired connection with a different host 10, then the other different host is operated to display its unique pairing symbol 20, and the reader 30 is operated to read this other pairing symbol 20, and the paired connection with this other different host is performed, as described above, by extracting the parameters of this other pairing symbol 20.

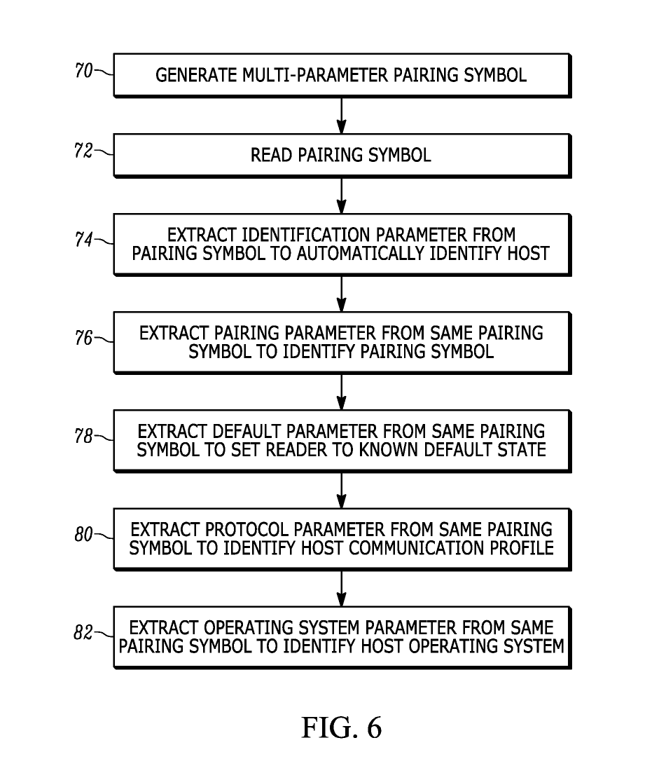

Turning now to the flow chart of FIG. 6, the method of establishing a wireless, Bluetooth® paired connection between the host 10 and the wireless reader 30 is performed by generating the multi-parameter, pairing symbol 20 in step 70. The pairing symbol 20 includes an identification parameter 68 for identifying the host 10, and further includes at least another configuration parameter 60, 62, 64, or 66 for configuring the paired connection between the reader 30 and the host 10. In step 72, the pairing symbol is read by the reader 30. The reader controller 42 then extracts the identification parameter from the pairing symbol 20 to automatically identify the host 10 in step 74. In steps 76, 78, 80, and 82, the reader controller 42 also substantially simultaneously extracts the pairing, default, protocol, and operating system parameters, respectively, from the same pairing symbol 20 to automatically configure the paired connection between the reader 30 and the host 10.

In the foregoing specification, specific embodiments have been described. However, one of ordinary skill in the art appreciates that various modifications and changes can be made without departing from the scope of the invention as set forth in the claims below. As used herein, the term Bluetooth® refers to both the classic version, and its modified versions, especially the Bluetooth® Low Energy (BLE) version, as well as both discoverable and non-discoverable versions thereof. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements, but may include other elements not expressly listed or inherent to such process, method, article, or apparatus. An element proceeded by “comprises . . . a,” “has . . . a,” “includes . . . a,” or “contains . . . a,” does not, without more constraints, preclude the existence of additional identical elements in the process, method, article, or apparatus that comprises, has, includes, or contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1%, and in another embodiment within 0.5%. The term “coupled” as used herein is defined as connected, although not necessarily directly and not necessarily mechanically. A reader or structure that is “configured” in a certain way is configured in at least that way, but may also be configured in ways that are not listed.

It will be appreciated that some embodiments may be comprised of one or more generic or specialized processors (or “processing readers”) such as microprocessors, digital signal processors, customized processors, and field programmable gate arrays (FPGAs), and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage reader, a magnetic storage reader, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein, will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. An arrangement for establishing a wireless paired connection between a host and a wireless reader for electro-optically reading symbols, the arrangement comprising:
a host controller associated with the host, and operative for generating a multi-parameter, pairing symbol that includes an identification parameter for identifying the host, and that further includes at least another configuration parameter for configuring the paired connection between the reader and the host;
a host wireless module associated with the host, and controlled by the host controller;
a data capture assembly associated with the reader, and operative for electro-optically reading the pairing symbol;
a reader controller associated with the reader, and operative for controlling the data capture assembly;
a reader wireless module associated with the reader, and controlled by the reader controller;
the reader controller being further operative for establishing the paired connection between the host wireless module and the reader wireless module by extracting the identification parameter from the pairing symbol to automatically identify the host, and by substantially simultaneously extracting the configuration parameter from the same pairing symbol to automatically configure the paired connection between the reader and the host.

2. The arrangement of claim 1, and a display associated with the host, and controlled by, the host controller; and wherein the host controller displays the pairing symbol on the display.

3. The arrangement of claim 1, wherein the data capture assembly includes a solid-state imager for capturing an image of the pairing symbol, and wherein the reader controller is operative for processing the image of the pairing symbol to extract the parameters.

4. The arrangement of claim 1, wherein the data capture assembly includes a scan component for moving a laser beam across the pairing symbol for reflection therefrom, and a detector for detecting return light from the pairing symbol, and wherein the reader controller is operative for processing the return light from the pairing symbol to extract the parameters.

5. The arrangement of claim 1, and an actuator associated with the reader to initiate reading of the pairing symbol when actuated, and wherein the reader controller extracts the parameters from the pairing symbol in response to a single actuation of the actuator.

6. The arrangement of claim 1, wherein the configuration parameter includes at least one of a pairing parameter to identify that a symbol being read is the pairing symbol, a default parameter to set the reader to a known default state, a protocol parameter to identify a communication profile being used by the host, and an operating system parameter to identify an operating system being used by the host.

7. The arrangement of claim 6, wherein the pairing symbol includes the pairing parameter, the default parameter, the protocol parameter, and the operating system parameter.

8. The arrangement of claim 6, wherein the protocol parameter is selected from a group that includes a human interface device (HID) profile, a simple serial interface (SSI) profile, a serial port profile (SPP), and a wireless made for iOS (MFi) profile.

9. The arrangement of claim 1, wherein the host is one of a plurality of hosts operative for generating a corresponding plurality of pairing symbols, each unique for each host.

10. A method of establishing a wireless paired connection between a host and a wireless reader for electro-optically reading symbols, the method comprising:
generating a multi-parameter, pairing symbol that includes an identification parameter for identifying the host, and that further includes at least another configuration parameter for configuring the paired connection between the reader and the host;
associating a host wireless module with the host;
electro-optically reading the pairing symbol;
associating a reader controller and a reader wireless module with the reader;
establishing the paired connection between the host wireless module and the reader wireless module by extracting the identification parameter from the pairing symbol to automatically identify the host, and by substantially simultaneously extracting the configuration parameter from the same pairing symbol to automatically configure the paired connection between the reader and the host.

11. The method of claim 10, and displaying the pairing symbol on a display.

12. The method of claim 10, wherein the reading of the pairing symbol is performed by capturing an image of the pairing symbol, and processing the image of the pairing symbol to extract the parameters.

13. The method of claim 10, wherein the reading of the pairing symbol is performed by moving a laser beam across the pairing symbol for reflection therefrom, and by detecting return light from the pairing symbol, and processing the return light from the pairing symbol to extract the parameters.

14. The method of claim 10, and initiating reading of the pairing symbol by actuating an actuator, and wherein the extracting of the parameters from the pairing symbol is performed in response to a single actuation of the actuator.

15. The method of claim 10, and configuring the configuration parameter to include at least one of a pairing parameter to identify that a symbol being read is the pairing symbol, a default parameter to set the reader to a known default state, a protocol parameter to identify a communication profile being used by the host, and an operating system parameter to identify an operating system being used by the host.

16. The method of claim 15, and configuring the pairing symbol to include the pairing parameter, the default parameter, the protocol parameter, and the operating system parameter.

17. The method of claim 15, and selecting the protocol parameter from a group that includes a human interface device (HID) profile, a simple serial interface (SSI) profile, a serial port profile (SPP), and a wireless made for iOS (MFi) profile.

18. The method of claim 10, wherein the host is one of a plurality of hosts, and generating a corresponding plurality of pairing symbols, each unique for each host.
